(19) United States
(12) Patent Application Publication
(10) Pub. No.: US 2013/0024239 A1
(43) Pub. Date: Jan. 24, 2013

(54) INSIDER THREAT DETECTION

(71) Applicants: Thomas Clayton Baker, Thousand Oaks, CA (US); Brett A. Nielson, Spangle, WA (US); Rangarajan Umamaheswaran, Simi Valley, CA (US); Bruce Wyatt Englar, Ventura, CA (US)

(72) Inventors: Thomas Clayton Baker, Thousand Oaks, CA (US); Brett A. Nielson, Spangle, WA (US); Rangarajan Umamaheswaran, Simi Valley, CA (US); Bruce Wyatt Englar, Ventura, CA (US)

(73) Assignee: BANK OF AMERICA CORPORATION, Charlotte, NC (US)

(21) Appl. No.: 13/187,296

(22) Filed: Jul. 20, 2011

(51) Int. Cl. G06Q 10/00

(52) U.S. Cl. 705/7.28

(57) ABSTRACT

Embodiments of the invention are directed to systems, methods and computer program products for determining a threat associated with an agent's provision of a service to an outsider. In some embodiments, a method includes: (a) receiving first information associated with the outsider, (b) receiving, from a data system, second information associated with the agent, where the agent provided the service to the outsider, and (c) determining a relationship between the outsider and the agent. In some embodiments, the method further includes: (d) receiving third information associated with the agent's provision of the service to the outsider, and (e) determining an abnormal event associated with the service.

### BACKGROUND

An entity that offers goods or services may employ one or more agents to render the goods or services on behalf of the entity. The entity may define one or more qualifications associated with the provision of the goods or services to outsiders (e.g., customers). Therefore, an entity may provide (e.g., sell) a service or good to an outsider if the outsider satisfies one or more qualifying criteria. For instance, an entity (e.g., a financial institution) may waive an assessment associated with a deposit account discrepancy if the outsider satisfies one or more criteria (e.g., the outsider has been an account holder for a predetermined number of years, the outsider's account has an account balance greater than a predetermined amount, and the like.). Further, the entity may assess or impose a payment for a service if the outsider exceeds or falls below one or more thresholds (e.g., the outsider may exceed a credit limit, the outsider's account balance may fall below an entity-defined minimum account balance, and the like.)

In some instances, an agent may, on behalf of the entity, provide a service to an outsider who is known to the agent (e.g., the agent's family, friend, acquaintance, and the like.) even though the outsider does not satisfy one or more qualifying criteria for the service. In such instances, the entity is harmed by potential losses incurred by outsiders who should not have been provided with the service. In other instances, an agent, on behalf of the entity, may not provide a service to an outsider known to the agent even though the outsider satisfies one or more qualifying criteria for the service. In such instances, the entity is harmed because the entity loses a potential profit associated with the provision of the good or service to the outsider.

Thus, there is a need to identify instances where: 1) an agent, on behalf of the entity, may provide a service to an outsider known to the agent (e.g., the agent's family, friend, acquaintance, and the like.) even though the outsider does not satisfy one or more qualifying criteria for the service, and 2) an agent, on behalf of the entity, may not provide a service to an outsider known to the agent even though the outsider satisfies one or more qualifying criteria for the service.

### BRIEF SUMMARY

Embodiments of the invention are directed to systems, methods and computer program products for determining a threat associated with an agent's provision of a service to an outsider. As used herein, an agent may be associated (e.g., employed) with an entity, and an outsider may be anybody who is not an agent, e.g., a customer or potential customer. In some embodiments, a method includes: (a) receiving first information associated with the outsider, (b) receiving, from a data system, second information associated with the agent, where the agent provided the service to the outsider, and (c) determining a relationship between the outsider and the agent. In some embodiments, the method further includes: (d) receiving third information associated with the agent's provision of the service to the outsider, and (e) determining an abnormal event associated with the service. Embodiments of the invention allow identification of instances where: 1) an agent, on behalf of the entity, may provide a service to an outsider known to the agent (e.g., the agent's family, friend, acquaintance, and the like.) even though the outsider does not satisfy one or more qualifying criteria for the service, and 2) an agent, on behalf of the entity, may not provide a service to an outsider known to the agent even though the outsider satisfies one or more qualifying criteria for the service.

### BRIEF DESCRIPTION OF THE DRAWINGS

Having thus described embodiments of the invention in general terms, reference will now be made to the accompanying drawings, where:

FIG. 1 is a flowchart illustrating a general process flow for determining a threat associated with an agent's provision of a service to an outsider, in accordance with embodiments of the present invention;

FIG. 2 is another flowchart illustrating a general process flow for determining a threat associated with an agent's provision of a service to an outsider, in accordance with embodiments of the present invention;

FIG. 3 is a block diagram illustrating technical components of a system for determining a threat associated with an agent's provision of a service to an outsider, in accordance with embodiments of the present invention; and

FIGS. 4-5 are illustrations of a graphical user interface initiated by a system that determines a threat associated with an agent's provision of a service to an outsider, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention allow a user to identify instances where: 1) an agent, on behalf of the entity, may provide a service to an outsider known to the agent (e.g., the agent's family, friend, acquaintance, and the like.) even though the outsider does not satisfy one or more qualifying criteria for the service, and 2) an agent, on behalf of the entity, may not provide a service to an outsider known to the agent even though the outsider satisfies one or more qualifying criteria for the service. One purpose of the invention is to ferret out an agent's motivation for misbehavior based on association.

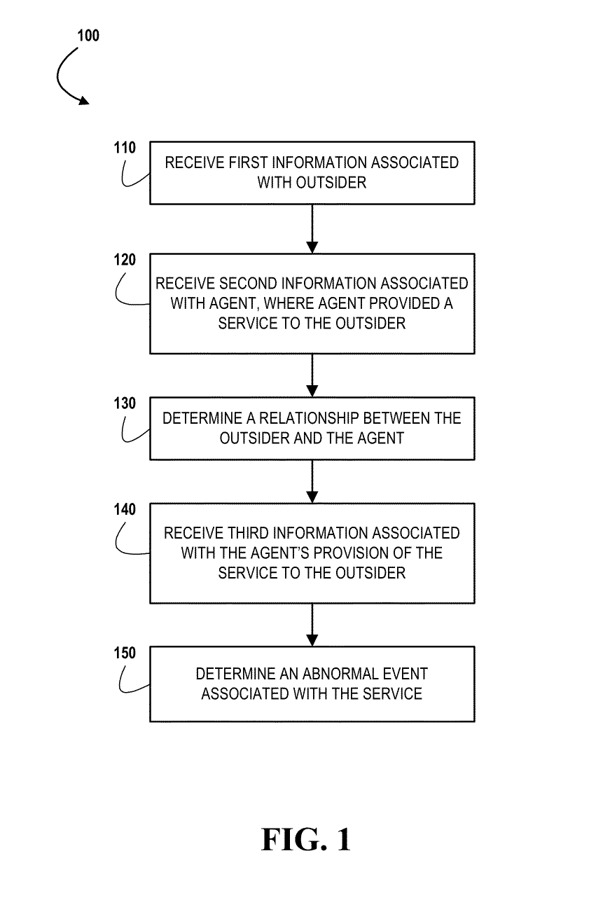

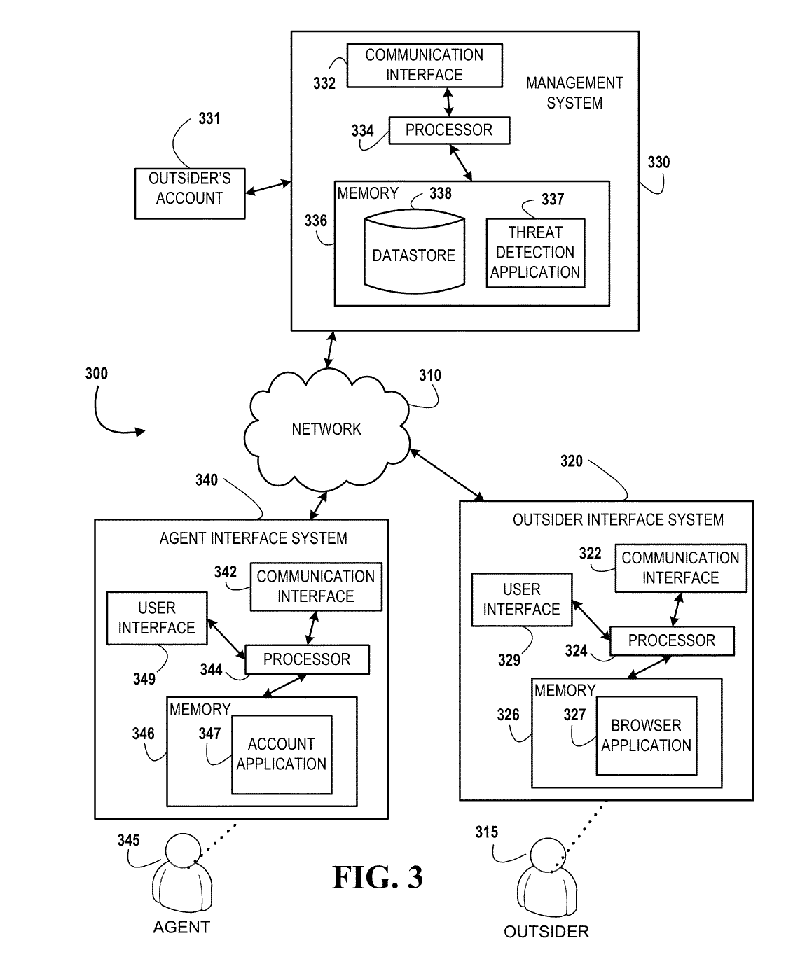

Referring now to FIG. 1, a general process flow 100 is provided for determining a threat associated with an agent's provision of a service to an outsider, in accordance with embodiments of the present invention. In some embodiments, the process flow 100 is performed by an apparatus (e.g., management system 330 illustrated in FIG. 3, and the like.) having hardware and/or software configured to perform one or more portions of the process flow 100. In such embodiments, as represented at block 110, the apparatus is configured to receive (e.g., from a data system) first information associated with the outsider. As represented at block 120, the apparatus is configured to receive (e.g., from a data system), second information associated with the agent, where the agent provided the service to the outsider. As represented at block 130, the apparatus is configured to determine a relationship between the outsider and the agent. As represented at block 140, the apparatus is configured to receive third information associated with the agent's provision of the service to the outsider. As represented at block 150, the apparatus is configured to determine an abnormal event associated with the service. In some embodiments, block 130 is performed after blocks 110 and 120 of the process flow. Therefore, for example, the receiving of the first information at block 110 and the receiving of the second information at block 120 triggers the apparatus to execute block 130, i.e., determine whether there is a relationship between the outsider and the agent. In some embodiments, block 150 is performed after block 140 of the process flow. Therefore, for example, the receiving the third information at block 140 triggers the apparatus to execute block 150, i.e., determine whether there is an abnormal event associated with the service provided by the agent.

In some embodiments, the agent is an employee of an entity. In other embodiments, the agent is not an employee of an entity, but still provides a service under the direction and/or supervision of the entity. Therefore, the agent may be associated with or affiliated with the entity. As used herein, an agent may also be referred to as an “insider.” In some embodiments, an outsider may be anybody who is not an agent, e.g., the outsider may be a customer or potential customer. Therefore, the outsider may receive a service provided by the agent. The entity may provide (e.g., sell) goods or services (e.g., banking services) to outsiders. In some embodiments, the entity may be any general organization (profit or non-profit) that employs (or contracts with) agents to provide goods or services to customers. In some embodiments, the entity may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow an outsider to establish an account with the entity. An “account” may be the relationship that the outsider has with the entity. Examples of accounts include a deposit account, such as a transactional account (e.g., a banking account), a savings account, an investment account, a money market account, a time deposit, a demand deposit, a pre-paid account, a credit account, and the like. The account is associated with and/or maintained by the entity.

Regarding block 110, the first information includes a first name, a last name, and contact information associated with the outsider. The outsider may include anybody who is not an agent, e.g., the outsider may be a customer (e.g., a person who has an account (e.g., banking account, credit account, and the like.) at the entity) or a potential customer (e.g., a person who has submitted an application for an account, a person who is the target of marketing materials that are distributed by the entity, a person who applies for a loan that not yet been funded). Therefore, the agent may provide a service to the outsider and/or to an account associated with the outsider. In other embodiments, the agent may interact with an account (e.g., search for and view account information) provided by the outsider. In some embodiments, the outsider may even be someone who is neither a current customer nor a potential customer. For example, the outsider may be someone who posted comments about the entity on a public blogging website. As a further example, the outsider may be someone who submitted a question to the entity electronically or mailed a question to the entity via postal mail. As a further example, the outsider may be someone who is generally browsing a website associated with the entity, or may even be someone who is reading a news article regarding the entity that is posted on a news website not controlled by or associated with the entity. As a further example, the outsider may be another agent associated with the entity. This other agent may be acting on behalf of or to the detriment of an agent associated with the entity.

The contact information associated with the outsider may include, for example, a phone number, a mailing address, and an email address. The mailing address may either be a postal mailing address or a physical mailing address. This information may be provided by the outsider who fills out an electronic form via a computing system associated with the outsider and transmits the information to a system associated with the entity. In other embodiments, the outsider may provide the information via a paper-based form that may be mailed to the entity or delivered in person to the entity. An agent associated with the entity may subsequently input the information into a computing system associated with the entity. In some embodiments, the first information may also include an identification code assigned by the entity to the outsider. This identification code may be assigned based on the mailing address provided by the outsider.

In some embodiments, the first information further includes a username created by the outsider for an account associated with the outsider, or a username granted to the outsider by the entity for an account associated with the outsider. In some embodiments, the first information further includes the unique portion associated with the email address provided to the entity by the outsider (e.g., outsider123 from outsider123@email.com). In some embodiments, the first information further includes a username (or an alias/screen name/nick name) associated with the outsider on an external public or private network or service (e.g., on a social network, discussion forum, website, multimedia network, gaming network, and the like.). The username may function as an authentication credential to authenticate the outsider to the public or private network. As used herein, a network includes a service.

With respect to the first information, the first information also includes partial portions of each element of first information. Therefore, the first information may include a partial portion of the first name, last name, telephone number, mailing address, email address, username (or alias/screen name/nick name), or any other element of the first information. Therefore, partial portions of the first information may be compared to partial portions of the second information (described later) to determine whether a relationship exists between the outsider and the agent.

In some embodiments, the first information further includes an address associated with the computing system via which the outsider transmitted information to a computing system associated with the entity. The address associated with this computing system may provide information regarding the identity and/or location (e.g., physical location or network location) of the outsider. In some embodiments, the address may be a network location associated with the computing system with which the outsider provided the first information (e.g., network address (e.g., Internet Protocol (IP) address), port number, and the like.). In other embodiments, the address may be a location of a cell site that is located nearest to the computing system with which the outsider provided the first information (e.g., when the outsider's computing system is a mobile system and transmits information to the entity's system (or accesses an account maintained by the entity) via the cell site). In some embodiments, the network address may also provide information regarding the outsider's computing system's physical address. In still other embodiments, the address associated with the computing system may be a unique identifier associated with the computing system's network interface card (e.g., Media Access Control (MAC) address) via which the outsider transmitted information to a computing system associated with the entity.

In still other embodiments, the first information further includes information associated with a cookie that is stored on the computing system via which the outsider transmitted information to a computing system associated with the entity. The cookie may provide information regarding the software application (e.g., web browser) via which the outsider transmitted information to a computing system associated with the entity. The cookie may further provide information regarding the computing system via which the outsider transmitted information to a computing system associated with the entity. The cookie may also further provide information regarding the outsider's account (e.g., the outsider's account with the entity) via which the outsider transmitted information to a computing system associated with the entity. Therefore, the cookie may provide information regarding the identity and/or location of the outsider.

In still other embodiments where the outsider has an account at the entity (e.g., a financial institution), the first information may further include transactional level information (e.g., the transaction history) associated with the outsider's account, such as checking transactions, ATM transactions, and credit/debit card transactions that allow for determination of the outsider's transactional behaviors. As used herein, a “transaction” may be monetary in nature (e.g., a purchase via a credit card; depositing a deposit item, e.g., a check, in an account; requesting a credit or cash advance; a stock trade or the like) or non-monetary in nature (e.g., a telephone call; an encounter with an agent; an identity authentication process, such as a biometric identity authentication process; recorded use of a utility, such as electricity and the like). Additionally, the first information may further include account information regarding the outsider's account, such as account balances and the like, age of the account, other joint account holders associated with the outsider's account, whether outsider's account was previously determined to be risky, any remarks associated with the outsider's account, assessments or fines incurred by the account, interest accrued by the account, and the like.

Further, the first information may further include other information such as personal information, profile information, demographics information, and the like. In addition, the apparatus may receive first information regarding the outsider from non-financial institutions, such as consumer bureaus, business bureaus, retailers (online and brick & mortar) government agencies, Internet Service Providers (ISPs), telephone companies (Telcos), health care industry entities, and the like. The information obtained from consumer bureaus may include payment status on bills, payment status on accounts at other financial institutions, credit utilization ratios, length and variety of credit history, instances of credit inquiries, instances of account discontinuations, instances of liquidation filings, instances of other repayment failures, or the like. Further, the first information may include behavioral information associated with the outsider, such as purchasing or browsing behaviors, and the like. Each of the various types of first information associated with the outsider may be captured in one or more datastore that allow for analytics and/or logic to be performed on the information for the purpose of leveraging the collected information to execute various routines/logic.

Regarding block 120, the agent may be an employee of the entity. In other embodiments, the agent may not be an employee of an entity, but still provides a service under the direction and/or supervision of the entity. Therefore, the agent may provide a service to the outsider and/or to an account associated with the outsider (examples are discussed below with respect to block 140). In other embodiments, the agent may interact with the outsider or with an account associated with the outsider (examples are discussed below with respect to block 140).

Regarding block 120, the second information may include information similar to the first information discussed with respect to block 110. For example, the second information includes a first name, a last name, and contact information associated with the agent. The contact information may include, for example, a phone number, a mailing address, and an email address. The mailing address may either be a postal mailing address or a physical mailing address.

In some embodiments, the second information further includes a username created by the agent for accessing (and/or authenticating into) a user interface and various applications associated with an agent's workstation, or a username granted to the agent by the entity for accessing the user interface and various applications associated with an agent's workstation. In some embodiments, the second information further includes the unique portion associated with the email address provided by the entity to the agent (e.g., agent123 from agent123@entity.com). In some embodiments, the second information further includes a username (or an alias/screen name/nick name) associated with the agent on an external public or private network or service (e.g., on a social network, discussion forum, website, multimedia network, gaming network, and the like.). In some embodiments, the agent may provide one or more types of second information to the entity. In other embodiments, the entity may execute an investigative application that searches for, accesses, and stores the various types of second information associated with an agent.

With respect to the second information, the second information also includes partial portions of each element of second information. Therefore, the second information may include a partial portion of the first name, last name, mailing address, telephone number, email address, username (or alias/screen name/nick name), or any other element of the second information. Therefore, partial portions of the first information may be compared to partial portions of the second information to determine whether a relationship exists between the outsider and the agent.

In some embodiments, the second information may further include an address (e.g., a network address) associated with a system (e.g., a personal computing system) or an account (e.g., a personal email account) to which the agent transmitted information from the agent's workstation. The network address associated with this personal computing system may provide information regarding the identity and/or location of the agent. In some embodiments, the second information further includes an address (e.g., network address (e.g., Internet Protocol (IP) address), port number, and the like.) associated with an agent's personal computing system via which the agent may access the agent's user interface provided by the entity (e.g., when the agent chooses to work from a location outside the entity). In other embodiments, the address may be a location of a cell site that is located nearest to the agent's personal computing system (e.g., when the personal computing system is a mobile system and connects to the entity's system via the cell site). In still other embodiments, the address associated with the agent's personal computing system may be a unique identifier associated with the personal computing system's network interface card (e.g., Media Access Control (MAC) address).

In still other embodiments, the second information further includes information associated with a cookie that is stored on the agent's personal computing system. The cookie may provide information regarding the software application (e.g., web browser) via which the agent accessed the agent's user interface provided by the entity. The cookie may further provide information regarding the agent's personal computing device. The cookie may provide information regarding the identity and/or location (e.g., physical location or network location) of the agent. Each of the various types of second information associated with the agent may be captured in one or more datastores that allow for analytics and/or logic to be performed on the information for the purpose of leveraging the collected information to execute various routines/logic.

Regarding block 130, the apparatus may determine whether there is a relationship between the outsider and the agent, where the agent provided a service to the outsider or the outsider's account (or the agent interacted with the outsider or the outsider's account). The apparatus' determining a relationship between the outsider and the agent may include determining whether there is a match (to a predetermined degree of reliability or confidence) between any part of the first information received at block 110 and any part of the second information received at block 120.

In some embodiments, the apparatus may compare like elements (or a partial portion of each element) associated with both the first information and the second information. For example, the apparatus may determine whether the last name associated with the first information (i.e., associated with the outsider) matches the last name associated with the second information (i.e., associated with the agent). However, this comparison procedure may generate many ‘hits,’ and therefore, in some embodiments, a determination that the only match between the first and second information is a last name is not reliable enough to determine that the outsider is related to the agent. Therefore, in instances whether the last name of the outsider matches the last name of the agent, the apparatus may determine that the outsider is related to the agent only if some other element of the first information (e.g., mailing address, telephone number, email address, and the like.) matches a like element of the second information. If the apparatus determines that some other element of the first information (apart from the last name) matches a like element of the second information, the apparatus may determine that the match between the first and second information meets a predetermined reliability threshold. The reliability threshold may vary from one group of outsiders to another group of outsiders.

In the case of a mailing address, different people may define the same address in multiple ways. For example, the outsider may define the outsider's mailing address as “6202 Outsider Pkway Apt 00/00-ABC Outsider 00000,” while the agent may define the agent's mailing address as “Apt 00/00 ABC 620 Outsider Parkway Outsider 00000.” Therefore, with respect to a mailing address, the apparatus may determine that an outsider is related to an agent if the mailing address associated with the first information matches to a predetermined degree of reliability the mailing address associated with the second information. For instance, for the above example, the apparatus may determine that the mailing address provided by the outsider matches, to a predetermined degree of reliability, the mailing address provided by the agent. The predetermined degree of reliability (or the reliability threshold) may vary from one group of outsiders to another group of outsiders.

In some embodiments, the apparatus may compare an element (or a partial portion of an element) associated with the first information with an unlike element (or a partial portion of an element) associated with the second information. For instance, the apparatus may compare a username associated with the agent (from the second information) with an email address provided by the outsider (from the first information). If the username associated with the agent (e.g., out123) matches the username portion of the email address provided by the outsider (e.g., out123@email.com), the apparatus may determine that the agent is related to the outsider. As a further example, the apparatus may compare a home telephone number associated with the agent (from the second information) with a mobile telephone number associated with the outsider (from the first information). As a further example, the apparatus may compare the agent's name or a username associated with the agent (from the second information) with information associated with a cookie received from a computing system associated with the outsider (from the first information) to determine whether any information associated with the cookie matches the agent's name and/or username.

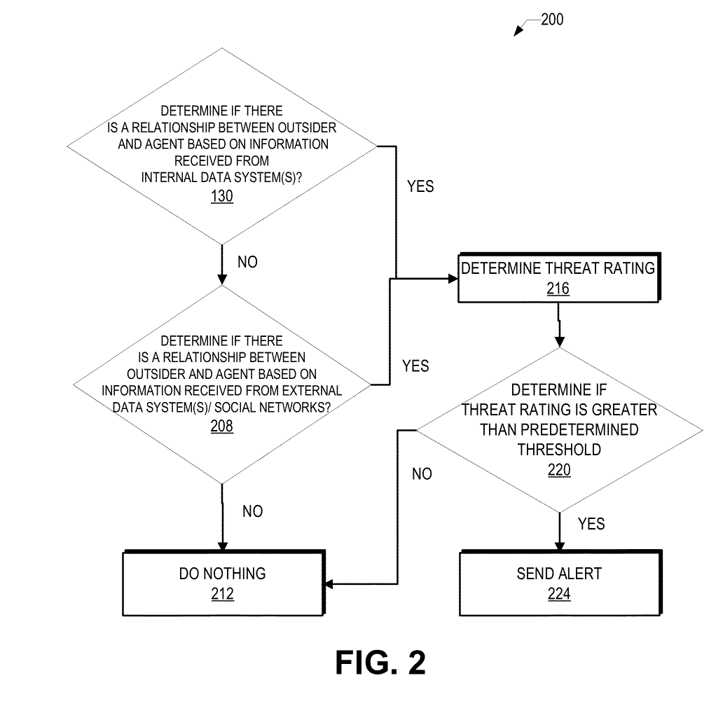

As explained above, both the first information and the second information may be received from internal data systems. As explained with respect to FIG. 2, in some embodiments, the apparatus may determine whether there is a relationship between the outsider and the agent by receiving, or pulling, information from external data systems such as social networks or the like associated with the outsider and/or the agent.

Furthermore, in some embodiments, determining a relationship between the outsider and the agent may not include determining whether there is a match between first information associated with an outsider and second information associated with an agent, where the agent does not provide a service to the outsider. Therefore, the apparatus may not compare all the outsiders (e.g., customers) with all the agents associated with an entity to determine whether any outsider is related to any agent.

Regarding block 140, the third information may include information regarding an instance of a service provided by the agent to the outsider, where the service may or may not be associated with the outsider's account (or the outsider's prospective account). The third information associated with the service may be captured in one or more datastores that allow for analytics and/or logic to be performed on the information for the purpose of leveraging the collected information to execute various routines/logic. The service may be a monetary or non-monetary service. In addition, the service may be an account-related or a non-account related service. For example, the service may be an instance where the agent changes the status of an outsider, where the outsider may or may not qualify for the changed status. The outsider may or may not have knowledge that the agent changed the status of the outsider. Moreover, the entity may not have authorized (or may have been duped into authorizing) the agent to change the status of the outsider. As a further example, the service may be an instance where the agent provides a reward to the outsider, where the outsider may or may not qualify for the reward. The outsider may or may not have knowledge that the agent provided a reward to the outsider. Moreover, the entity may not have authorized (or may have been duped into authorizing) the agent to provide a reward to the outsider. For example, the service may be an instance where the agent waives an assessment for the outsider, where the outsider may or may not qualify for an assessment waiver. The outsider may or may not have knowledge that the agent waived an assessment for the outsider. Moreover, the entity may not have authorized (or may have been duped into authorizing) the agent to waive an assessment for the outsider. As a further example, the service may be an instance where the agent lowers or increases an interest rate associated with the outsider's account, where the account may or may not qualify for the lower or the higher interest rate. The outsider may or may not have knowledge that the agent lowered or increased the interest rate for the outsider's account. Moreover, the entity may not have authorized (or may have been duped into authorizing) the agent to lower or increase the interest rate associated with the outsider's account. As a further example, the service may be an instance where the agent lowers or raises a credit limit associated with the outsider's account, where the account may or may not qualify for the lower or higher credit limit. The outsider may or may not have knowledge that the agent lowered or increased the credit limit for the outsider's account. Moreover, the entity may not have authorized (or may have been duped into authorizing) the agent to lower or increase the credit limit associated with the outsider's account. As a further example, the service may be wiring funds into and/or out of the outsider's account. This wiring of funds may be executed by the agent with or without the permission (and/or knowledge) of the outsider and/or the entity. As a further example, the service may be ordering a checkbook associated with the outsider's account. The ordering of a checkbook may be executed by the agent with or without the permission or knowledge of the outsider (and/or the permission or knowledge of the entity). As a further example, the service may be ordering an extra credit card associated with the outsider's account. The ordering of an extra credit card may be executed by the agent with or without permission or knowledge of the outsider (and/or the permission or knowledge of the entity).

Regarding block 140, the third information may also include an instance where the agent interacts with the outsider or with an account associated with the outsider. For instance, the agent may run a search query for a particular account. As a further example, the agent may access the outsider's account and read information (e.g., name, contact information, account number, social security number, account balance, payment terms, transaction history, and the like.) associated with the account. In some embodiments, the agent may edit the account information (e.g., edit a mailing address or other contact information) with or without the permission or knowledge of either the outsider or the entity. In some embodiments, the agent may even transmit the account information to an external system (e.g., the agent's personal email account, the agent's personal portable data storage system) with or without the permission or knowledge of either the outsider or the entity. The third information may also include instances where the agent interacts with the outsider in-person, or via phone, chat, email, and the like. For example, the agent may receive information from an outsider via phone and may memorialize (e.g., write on paper and store it) the information (e.g., account number) at a later point in time.

Regarding block 150, the apparatus may determine whether an abnormal event is associated with the received third information (i.e., block 140). The apparatus may determine an abnormal event when the agent executes an action with respect to an outsider (or an outsider's account) that other comparable agents would not execute (e.g., other agents who have responsibilities similar to the agent). For example, the apparatus may determine that the agent provided a benefit to (or changed the status associated with) the outsider, where the outsider did not qualify for the benefit (or the changed status) at the time of providing the benefit. For example, the service may be an instance where the agent waives an assessment for the outsider, where the outsider may not qualify for an assessment waiver. As a further example, the service may be an instance where the agent lowers an interest rate associated with the outsider's account, where the account may not qualify for the lower interest rate. As a further example, the service may be an instance where the agent raises a credit limit associated with the outsider's account, where the account may not qualify for the lower or higher credit limit. As a further example, the service may be wiring funds into an outsider's account without the permission (and/or knowledge) of the outsider.

As a further example, the apparatus may determine that the agent caused a detriment (e.g., a reduction in status) to the outsider, where the outsider did not qualify for the detriment at the time of causing the detriment to the outsider. As used herein, a detriment is a harm caused to the outsider, or a disadvantage or disbenefit incurred by the outsider. For example, the service may be an instance where the agent imposes an assessment (e.g., assessments for maintaining an investment account) for an outsider event though the outsider may qualify for an assessment waiver. As a further example, the service may be an instance where the agent increases an interest rate associated with the outsider's account, where the account may still qualify for the lower interest rate. As a further example, the service may be an instance where the agent lowers a credit limit associated with the outsider's account, where the account may still qualify for the higher credit limit. As a further example, the service may be wiring funds out of an outsider's account without the permission (and/or knowledge) of the outsider. Regardless of whether the agent provides a benefit or causes a detriment to the outsider by providing the service to the outsider, the agent's provision of the service may not benefit the entity.

In some embodiments, the apparatus optionally executes block 150. Therefore, in some embodiments, the apparatus automatically sends an alert to (or generates a report for) personnel associated with the entity when the apparatus determines a relationship (block 130) between the outsider and the agent, regardless of whether the apparatus determines an abnormal event associated with the service provided by the agent.

Regarding blocks 130 and 150, or other any process block of FIGS. 1 and 2, it will be understood that, in some embodiments, the term “determine” is meant to have its one or more ordinary meanings (i.e., its ordinary dictionary definition(s)), but in other embodiments, that term is additionally or alternatively meant to include the one or more ordinary meanings of one or more of the following terms: conclude, decide, identify, ascertain, find, discover, learn, verify, calculate, observe, read, extract, and/or the like. Further, it will be understood that, in some embodiments, the phrase “based at least partially on” is meant to have its one or more ordinary meanings, but in other embodiments, that phrase is additionally or alternatively meant to include the one or more ordinary meanings of one or more of the following phrases: “in response to,” “upon or after,” “because of,” “as a result of,” “if,” “when,” and/or the like.

In some embodiments, the apparatus having the process flow 100 can be configured to perform any one or more portions of the process flow 100 represented by blocks 110-150 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within seconds or minutes), or sometime after the occurrence of the triggering event. For example, in some embodiments, the apparatus is configured such that the apparatus first receives third information associated with an agent's provision of a service to an outsider and determines an abnormal event associated with the service. The determining an abnormal event associated with the service triggers the apparatus to determine whether there is a relationship between the outsider and the agent. In order to make this determination, the apparatus receives first information associated with the outsider and second information associated with the agent who provided the service to the outsider. In other embodiments, the apparatus is configured such that the apparatus first receives first information associated with an outsider and then receives second information associated with the agent who provided the service to the outsider. Alternatively, the apparatus may first receive second information associated with the agent who provided the service to the customer and then receive first information associated with the outsider. Then, the apparatus may determine whether there is a relationship between the outsider and the agent. If the apparatus determines there is a relationship between the outsider and the agent, this determination triggers the apparatus to receive third information associated with an agent's provision of a service to an outsider and then the apparatus determines whether there is an abnormal event associated with the service provided by the agent.

In some embodiments, a predetermined time and/or the passage of a predetermined period of time may serve to trigger one or more of the portions represented by blocks 110-150. Also, in some embodiments, the apparatus is configured to automatically perform one or more (or all) of the portions of the process flow 100 represented by blocks 110-150. In other embodiments, one or more (or all) of the portions of the process flow 100 represented by blocks 110-150 require and/or involve at least some human intervention. In addition to the process flow 100, any of the embodiments described and/or contemplated herein can involve one or more triggering events, triggered actions, automatic actions, apparatus actions, and/or human actions.

It will also be understood that the apparatus having the process flow 100 may be configured to perform any one or more portions of any embodiment described and/or contemplated herein, including, for example, any one or more portions of the process flow 200 described later herein. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions.

Referring now to FIG. 2, a flowchart 200 is provided for determining a threat associated with an agent's provision of a service to an outsider, in accordance with some embodiments of the invention. In some embodiments, the process flow 200 is performed by an apparatus having hardware and/or software configured to perform one or more portions of the process flow 100.

At block 130, the apparatus may determine whether there is a relationship between the outsider and the agent based on information regarding the agent received from internal data systems, the outsider, and the service provided by the agent. The internal data systems may be owned and maintained by the entity associated with the agent. Block 130 has been explained in detail with respect to FIG. 1. If, at block 130, the apparatus determines there is a relationship between an outsider and an agent based on information received from an internal data system, then the process flow moves directly to block 216 and may not receive data from one or more external data systems to determine whether there is a relationship between the outsider and the agent. If, at block 130, the apparatus determines there is no relationship between an outsider and an agent based on information received from an internal data system, the process flow moves to block 208. In some embodiments, the process flow moves to block 208 to determine whether there is a relationship between the outsider and the agent based on information received from an external data system even when the apparatus has determined, at block 130, that there is a relationship between the outsider and the agent based on information received from an internal data system.

Thereafter, as represented by block 208, the apparatus may determine whether there is a relationship between an outsider and an agent based on data received from one or more external data systems. As used herein, an external data system is a data system that may not be owned or maintained by the entity. In some embodiments, an external data system may be a social network (or a plurality of social networks). In some embodiments, the apparatus may first search, on a social network, for a social network account associated with the outsider. In order to positively identify the outsider's social network account, the apparatus may determine whether there is a match between information associated with the outsider's social network account and first information received by the apparatus. Once the apparatus positively identifies the outsider's social network account, the apparatus may pull (or may receive) information regarding the outsider's social network account. The outsider may be connected to one or more connections via the outsider's social network account. As used herein, a “connection” is a person or a bot (or a social network account associated with a person or a bot) that the outsider is connected to (e.g., directly connected to) via the social network. The outsider may also be part of one or more social network groups via the outsider's social network account. Therefore, the apparatus may receive information regarding the list of connections that the outsider is connected to and the list of social network groups in which the outsider has enrolled. The apparatus may scan the names of the received list of connections to determine whether the agent is among the list of connections. If the apparatus determines that the agent is a connection among the list of connections associated with the outsider's social network account, then the apparatus may determine that there is a relationship between the outsider and the agent.

Additionally, the apparatus may receive one or more other elements of information from the outsider's social network. For example, the apparatus may receive the outsider's profile information such as the outsider's name, contact information, interests, applications for which the outsider's account is enrolled, and any other information that the outsider provides to the social network (or one or more applications associated with the social network) and/or shares with one or more direct or indirect connections. For instance, the outsider may share messages received from the outsider's connections (or other non-connections) and sent from the outsider to the outsider's connections (or other non-connections). Additionally, the outsider may share pictures, videos, and the like. Additionally, the outsider may share links to news articles, multimedia, and the like.

In some embodiments, in order to determine where there is a relationship between an agent and an outsider, the apparatus may compare second information associated with an agent (received from an internal data system) with information received from an outsider's social network. For example, the apparatus may determine whether the last name associated with the outsider's social network account matches the last name associated with the second information (i.e., associated with the agent). As a further example, the apparatus may determine whether contact information (e.g., mailing address, telephone number, email address) associated with the outsider's social network account matches the contact information associated with the second information (i.e., associated with the agent). As a further example, the apparatus may determine whether a username (or a display name or an alias) associated with the outsider's social network account matches a username associated with the second information (i.e., associated with the agent) or a username portion of an email address associated with the second information. As a further example, the apparatus may compare elements of the second information (e.g., the agent's name, a username associated with the agent on a public or private network) with information associated with a cookie received from the outsider's social network account to determine whether any information associated with the cookie matches any element of the second information (e.g., the agent's name and/or username). The elements of the second information that are compared to information received from an outsider's social network are not limited to those described here.

In some embodiments, the apparatus may compare first information associated with an outsider (received from an internal data system) with information received from the outsider's social network (or another external data system that stores information regarding the outsider). The apparatus may execute this comparison in order to verify the truthfulness of the information provided to the entity by the outsider. This comparison step may be executed by the apparatus prior to comparing the second information associated with an agent (received from an internal data system) with the first information associated with an outsider (received from an internal data system) and/or information associated with the outsider's social network (or another external data system that stores information regarding the outsider).

In some embodiments, the apparatus may determine that the agent is not a connection among the outsider's list of connections. In such embodiments, the apparatus may determine whether there is an indirect connection between the outsider and the agent via a connection path that includes one or more connections, where the connection path selected by the apparatus is a shortest connection path among a plurality of connection paths that connect the outsider and the agent. Therefore, an outsider (Outsider No. 1) may be directly connected to Outsider No. 2. Outsider No. 2 may, in turn, be connected to Outsider No. 3. Outsider No. 3 may, in turn, be connected to the agent (Agent No. 1). Therefore, the connection length of the connection path between Outsider No. 1 and Agent No. 1 includes two connections, and Agent No. 1 is consequently three degrees away from Outsider No. 1. In some embodiments, the apparatus may determine that that there is a relationship between the outsider and the agent if the connection path between the outsider and the agent is smaller than a predetermined connection path length (e.g., 3 connections). Therefore, in the above described embodiment, the apparatus may determine that there is relationship between Outsider No. 1 and the Agent No. 1 because the connection path length between Outsider No. 1 and Agent No. 1 is two connections. If the only connection path between Outsider No. 1 and Agent No. 1 includes three or more connections (e.g., Outside No. 1 is connected to outsider No. 2 who is connected to Outsider No. 3 who is connected to Outsider No. 4 who is connected to Agent No. 1), then the apparatus may determine that there is no relationship between Outsider No. 1 and Agent No. 1.

In some embodiments, there may be multiple connection paths between the agent and the outsider. In such embodiments, the apparatus considers the shortest connection path between the outsider and the agent in order to determine whether there is a relationship between the outsider and the agent. Therefore, for example if Outsider No. 1 is connected to Agent No. 1 via two paths, where one path includes two connections and the other path includes three connections, the apparatus only considers the connection path that includes two connections in determining whether there is a relationship between Outsider No. 1 and Agent No. 1.

As described previously, an agent may be an individual associated with an account on a network (e.g., a social network) and an outsider may be another individual associated with another account on the network. In some embodiments, if there are multiple connection paths between the agent and the outsider, the apparatus may consider the number and type of connection paths between the agent and the outsider in order to generate a “cumulative connectedness weight” factor (CCW). For instance, if there is a direct connection between the outsider and the agent (either based on data received from an internal data system or an external data system), the CCW may be ‘1’ which may be the maximum value that the CCW can take. If there are multiple connection paths between the outsider and the agent, each connection path contributes to the CCW. For example, if there are twenty second degree connections between the outsider and the agent, the CCW may be closer to 1 because the apparatus deduces that there is a high likelihood that the outsider is related to (e.g., knows) the agent. As a further example, if there are only two fifth degree connections between the outsider and the agent, the CCW may closer to 0 because the apparatus deduces that there is a low likelihood that the outsider is related to (e.g., knows) the agent. As a further example, if there are two second degree connections between the outsider and the agent, the CCW may be closer to 0.5 (e.g., 0.51) because the apparatus deduces that the outsider may or may not be related to the agent.

As a further example, if there are two second degree connections between the outsider and the agent along with three third degree connections between the outsider and the agent and twenty fourth degree connections between the outsider and the agent, the CCW may still be closer to 0.5 (e.g., 0.52) because the quality of a connection has a greater impact on the CCW than the number of connections. Therefore, the two second degree connections have a much greater impact on the CCW than the three third degree connections or the twenty fourth degree connections.

In some embodiments, the entity may set a predetermined CCW threshold in order to determine whether there is a relationship between the outsider and the agent. Therefore, for example, the entity may set the CCW threshold to be 0.76. In such embodiments, the apparatus may determine a relationship between the outsider and the agent only if the determined CCW is greater than 0.76. In some embodiments, the apparatus may determine that there is a relationship between the outsider and the agent even when the determined CCW is less than or equal to 0.76 if the number of interactions between the agent and the outsider (or the outsider's account) exceeded a predetermined threshold number of interactions (e.g., five interactions) during a predetermined period (e.g., the previous three months). In some embodiments, the apparatus may dynamically determine the predetermined threshold number of interactions for each agent-outsider pair.

In some embodiments, the apparatus may dynamically determine a CCW threshold. In some embodiments, the apparatus may dynamically determine a CCW threshold based at least partially on attributes or characteristics associated with the outsider and/or the agent. In some embodiments, the apparatus may dynamically set a lower CCW threshold if the apparatus determines that the agent has recently interacted with the outsider (or the outsider's account) within a predetermined period in the past. In some embodiments, the apparatus may dynamically set a lower CCW threshold if the apparatus determines that the agent interacted with the outsider (or the outsider's account) at least a predetermined number of times (e.g., ten times) within a predetermined period in the past (e.g., previous three months). In some embodiments, the apparatus may dynamically set a lower CCW threshold if the apparatus determines that the agent's interactions with the outsider (or the outsider's account) are unusually or abnormally greater than a comparable's agent's interactions with an outsider (or an outsider's account) over a predetermined period (e.g., previous three months). An unusual number of interactions over a predetermined period may indicate that the agent is engaging in activity that provides a benefit to or causes a detriment to the outsider. In other embodiments, an unusual or abnormal number of interactions over a predetermined period may indicate that the agent is testing the limits of the ‘threat detection’ application. In other embodiments, an unusual number of interactions over a predetermined period may indicate that the agent is in need of remedial training so that the agent can understand the dangers of accessing an outsider's account on multiple occasions within a short period of time.

In some embodiments, the CCW may be used to confirm a direct relationship between the agent and the outsider. Therefore, even if the apparatus determines, based at least partially on information received from internal and/or external data systems, a direct connection between the outsider and the agent, the apparatus may still calculate a CCW in order to confirm the direct connection between the outsider and the agent. Therefore, in some embodiments, the entity may set a predetermined CCW confirmation threshold in order to confirm the direct relationship between the agent and the outsider. For example, the entity may set the CCW confirmation threshold to be 0.36. In such embodiments, the apparatus may determine a direct relationship between the outsider and the agent only if the determined CCW is greater than 0.36. In some embodiments, the apparatus may determine that there is a direct relationship between the outsider and the agent even when the determined CCW is less than or equal to 0.36 if the number of interactions between the agent and the outsider (or the outsider's account) exceeded a predetermined threshold number of interactions (e.g., five interactions) during a predetermined period (e.g., the previous three months). In some embodiments, the apparatus may dynamically determine the predetermined threshold number of interactions for each agent-outsider pair.

In some embodiments, the apparatus may dynamically determine a CCW confirmation threshold. In some embodiments, the apparatus may dynamically determine a CCW confirmation threshold based at least partially on attributes or characteristics associated with the outsider and/or the agent. In some embodiments, the apparatus may dynamically set a lower CCW confirmation threshold if the apparatus determines that the agent has recently interacted with the outsider (or the outsider's account) within a predetermined period in the past. In some embodiments, the apparatus may dynamically set a lower CCW confirmation threshold if the apparatus determines that the agent interacted with the outsider (or the outsider's account) at least a predetermined number of times (e.g., ten times) within a predetermined period in the past (e.g., previous three months). In some embodiments, the apparatus may dynamically set a lower CCW confirmation threshold if the apparatus determines that the agent's interactions with the outsider (or the outsider's account) are unusually or abnormally greater than a comparable's agent's interactions with an outsider (or an outsider's account) over a predetermined period (e.g., previous three months). An unusual or abnormal number of interactions over a predetermined period may indicate that the agent is engaging in activity that provides a benefit to or causes a detriment to the outsider. In other embodiments, an unusual or abnormal number of interactions over a predetermined period may indicate that the agent is testing the limits of the ‘threat detection’ application. In other embodiments, an unusual number of interactions over a predetermined period may indicate that the agent is in need of remedial training so that the agent can understand the dangers of accessing an outsider's account on multiple occasions within a short period of time.

In alternate embodiments of block 208, the apparatus may first search, on a social network, for a social network account associated with the agent. In order to positively identify the agent's social network account, the apparatus may determine whether there is a match between information associated with the agent's social network account and second information received by the apparatus. Once the apparatus positively identifies the agent's social network account, the apparatus may pull (or may receive) information regarding the agent's social network account. The agent may be connected to one or more connections via the agent's social network account. The agent may also be part of one or more social network groups via the agent's social network account. Therefore, the apparatus may receive information regarding the list of connections that the agent is connected to and the list of social network groups in which the agent has enrolled. The apparatus may scan the names of the received list of connections to determine whether the outsider is among the list of connections. If the apparatus determines that the outsider is a connection among the list of connections associated with the agent's social network account, then the apparatus may determine that there is a relationship between the agent and the outsider.

Additionally, the apparatus may receive one or more other elements of information from the agent's social network. For example, the apparatus may receive the agent's profile information such as the agent's name, contact information, interests, applications for which the agent's account is enrolled, and any other information that the agent provides to the social network (or one or more applications associated with the social network) and/or shares with one or more direct or indirect connections. For instance, the agent may share messages received from the agent's connections (or other non-connections) and sent from the agent to the agent's connections (or other non-connections). Additionally, the agent may share pictures, videos, and the like. Additionally, the agent may share links to news articles, multimedia, and the like.

In some embodiments, in order to determine where there is a relationship between an agent and an outsider, the apparatus may compare first information associated with an outsider (received from an internal data system) with information received from an agent's social network. For example, the apparatus may determine whether contact information (e.g., mailing address, telephone number, email address) associated with the agent's social network account matches the contact information associated with the first information (i.e., associated with the outsider). As a further example, the apparatus may determine whether a username (or a display name or an alias) associated with the agent's social network account matches a username associated with the first information (i.e., associated with the outsider on a public or private network) or a username portion of an email address associated with the first information. As a further example, the apparatus may compare elements of the first information (e.g., the outsider's name, a username associated with the outsider on a public or private network) with information associated with a cookie received from the agent's social network account to determine whether any information associated with the cookie matches any element of the first information (e.g., the outsider's name and/or username). The elements of the first information that are compared to information received from an agent's social network are not limited to those described here.

In some embodiments, the apparatus may determine that the outsider is not a connection among the agent's list of connections. In such embodiments, the apparatus may determine whether there is an indirect connection between the agent and the outsider via a connection path that includes one or more connections, where the connection path selected by the apparatus is a shortest connection path among a plurality of connection paths that connect the outsider and the agent. Therefore, an agent (Agent No. 1) may be directly connected to Outsider No. 2. Outsider No. 2 may, in turn, be connected to Outsider No. 3. Outsider No. 3 may, in turn, be connected to the outsider Outsider No. 1. Therefore, the connection length of the connection path between Agent No. 1 and Outsider No. 1 includes two connections, and Agent No. 1 is consequently three degrees away from Outsider No. 1. In some embodiments, the apparatus may determine that that there is a relationship between the outsider and the agent if the connection path between the outsider and the agent is smaller than a predetermined connection path length (e.g., 3 connections). Therefore, in the above described embodiment, the apparatus may determine that there is relationship between the outsider Outsider No. 1 and the Agent No. 1 because the connection path length between Outsider No. 1 and Agent No. 1 is two connections. If the only connection path between Outsider No. 1 and Agent No. 1 includes three or more connections (e.g., Agent No. 1 is connected to Outsider No. 2 who is connected to Outsider No. 3 who is connected to Outsider No. 4 who is connected to outsider Outsider No. 1), then the apparatus may determine that there is no relationship between Outsider No. 1 and Agent No. 1. In some embodiments, there may be multiple connection paths between the agent and the outsider. In such embodiments, the apparatus considers the shortest connection path between the outsider and the agent in order to determine whether there is a relationship between the outsider and the agent. Therefore, for example if Agent No. 1 is connected to the outsider Outsider No. 1 via two paths, where one path includes two connections and the other path includes three connections, the apparatus only considers the connection path that includes two connections in determining whether there is a relationship between Outsider No. 1 and Agent No. 1.

In still other embodiments, in order to determine whether there is a relationship between the agent and the outsider, the apparatus may additionally and/or alternatively compare the information received from the agent's social network account (or other external data system) with the information received from the outsider's social network account (or other external data system). If the apparatus determines a match between the two sets of information to a predetermined degree of reliability, then the apparatus may determine that the agent is related to the outsider.

Thereafter, as represented by block 216, the apparatus may determine a threat rating by executing a function that takes as input the determined relationship between the outsider and the agent (block 130 and/or block 208), and/or the determined abnormal event associated with the service (block 150). In some embodiments, the apparatus may determine a threat rating by executing a function that takes as input only the determined relationship between the outsider and the agent (block 130 and/or block 208). In other embodiments, the apparatus may determine a threat rating by executing a function that takes as input only the determined abnormal event associated with the service provided by the agent (block 150).

Subsequently, at block 220, the apparatus may determine whether the determined threat rating is greater than a predetermined threshold rating. If the apparatus determines that the threat rating is greater than a predetermined threshold rating, then, as represented at block 224, the apparatus may be configured to generate an alert (and/or send a report to) one or more personnel associated with the entity. If the apparatus determines that the threat rating is not greater than a predetermined threshold rating, then, as represented at block 212, the apparatus may not be configured to generate an alert (and/or send a report to) one or more personnel associated with the entity. In some embodiments, the apparatus is automatically configured to generate and alert (and/or send a report to) one or more personnel associated with the entity if the apparatus determines that there is a relationship between an outsider and agent, regardless of whether the apparatus calculates a threat rating, and regardless of whether the threat rating is greater than a predetermined threshold rating.

In some embodiments, the threat rating may be a numerical score, where the score may be standardized on a continuous scale, such as a scale from 0 to 10. Each score may also be associated with a threat color, where the shade of the presented threat color graph (presented in an alert or a report) depends on the numerical score. For example, a threat rating of 0 may be associated with a white color graph, and a threat rating of 10 may be associated with a black color graph. As a further example, a threat rating of 3 is associated with a light grey color graph while a threat rating of 8 is associated with a dark grey color graph. In other embodiments, the threat rating may not be presented as a score, but as a color or as a letter or any other form of representation. Therefore, for example, a threat rating of ‘A’ (or the color ‘red’ or ‘black’) may correspond with risk scores from 7 to 10, a risk rating of ‘B’ (or the color ‘orange’ or ‘grey’) may correspond with risk scores from 3 to 7, and a risk rating of ‘C’ (or the color ‘green’ or ‘white’) may correspond with risk scores from 0 to 3.

In some embodiments, the apparatus having the process flow 200 may be configured to perform any one or more portions of the process flow 200 represented by blocks 130-224 upon or after one or more triggering events, which, in some embodiments, is one or more of the other portions of the process flow 200. As used herein, it will be understood that a “triggering event” refers to an event that automatically triggers the execution, performance, and/or implementation of a triggered action, either immediately, nearly immediately (i.e., within minutes), or sometime after the occurrence of the triggering event.

In some embodiments, a predetermined time and/or the passage of a predetermined period of time may serve to trigger one or more of the portions represented by blocks 130-224. Also, in some embodiments, the apparatus (e.g., the management system 330) may be configured to automatically perform one or more (or all) of the portions of the process flow 200 represented by blocks 130-224. In other embodiments, one or more (or all) of the portions of the process flow 200 represented by blocks 130-224 require and/or involve at least some human intervention. In addition to the process flow 200, any of the embodiments described and/or contemplated herein can involve one or more triggering events, triggered actions, automatic actions, apparatus actions, and/or human actions. In addition, the number, order, and/or content of the portions of the process flow 200 are exemplary and may vary. Indeed, the process flow 200, like all of the other process flows described herein, can include one or more additional and/or alternative process flow portions, and the apparatus configured to perform the process flow 200 can be configured to perform one or more additional and/or alternative functions.

Referring now to FIG. 3, a system 300 is presented for determining a threat associated with an agent's provision of a service to an outsider, in accordance with an embodiment of the present invention. As illustrated, the system 300 includes a network 310, an outsider interface system 320, a management system 330, and an agent interface system 340. FIG. 3 also illustrates an account 331 (e.g., the outsider's account), which is operatively connected (e.g., linked) to the management system 330. Also shown in FIG. 3 is an outsider 315 that has access to the outsider interface system 320. In this embodiment, the outsider interface system 320 is maintained by the outsider 315, while the management system 330, along with the account 331 and the agent interface system 340 are maintained by an entity.

As shown in FIG. 3, the outsider interface system 320, the management system 330, and the agent interface system 340 are each operatively and selectively connected to the network 310, which may include one or more separate networks. In addition, the network 310 may include a local area network (LAN), a wide area network (WAN), and/or a global area network (GAN), such as the Internet. It will also be understood that the network 310 may be secure and/or unsecure and may also include wireless and/or wireline and/or optical interconnection technology.

The outsider interface system 320 may include any computerized apparatus that can be configured to perform any one or more of the functions of the outsider interface system 320 described and/or contemplated herein. In some embodiments, for example, the outsider interface system 320 may include a personal computer system, a mobile computing device, a personal digital assistant, a public kiosk, a network device, and/or the like. As illustrated in FIG. 3, in accordance with some embodiments of the present invention, the outsider interface system 320 includes a communication interface 322, a processor 324, a memory 326 having a browser application 327 stored therein, and a user interface 329. In such embodiments, the communication interface 322 is operatively and selectively connected to the processor 324, which is operatively and selectively connected to the user interface 329 and the memory 326.

Each communication interface described herein, including the communication interface 322, generally includes hardware, and, in some instances, software, that enables a portion of the system 300, such as the outsider interface system 320, to transport, send, receive, and/or otherwise communicate information to and/or from the communication interface of one or more other portions of the system 300. For example, the communication interface 322 of the outsider interface system 320 may include a modem, server, electrical connection, and/or other electronic device that operatively connects the outsider interface system 320 to another electronic device, such as the electronic devices that make up the management system 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 327 of the memory 326 of the outsider interface system 320.

Each memory device described herein, including the memory 326 for storing the browser application 327 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 326 includes the browser application 327. In some embodiments, the browser application 327 includes a web browser and/or some other application for communicating with, navigating, controlling, configuring, and/or using the management system 330 and/or other portions of the system 300. For example, in some embodiments, the outsider 315 may use the browser application 327 to access and manage the outsider's account 331. The outsider 315 may also use the browser application 327 to transmit information to the entity. For instance, the outsider may use the browser application to fill out one or more electronic forms provided by the entity. For instance, the outsider may transmit to the management system 330 one or more pieces of information associated with the outsider. This information may include elements of the above-described first information, such as the name of the outsider, contact details of the outsider, and the like. Contact details of the outsider may include a mailing address, an email address, a telephone number, and the like. In some embodiments, the browser application 327 includes computer-executable program code portions for instructing the processor 324 to perform one or more of the functions of the browser application 327 described and/or contemplated herein. In some embodiments, the browser application 327 may include and/or use one or more network and/or system communication protocols.

Also shown in FIG. 3 is the user interface 329. In some embodiments, the user interface 329 includes one or more user output devices, such as a display and/or speaker, for presenting information to the outsider 315 and/or some other user. In some embodiments, the user interface 329 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the outsider 315 and/or some other user. In some embodiments, the user interface 329 includes the input and display devices of a personal computer, such as a keyboard and monitor, that are operable to receive and display information associated with the account.

The agent interface system 340 may include any computerized apparatus that can be configured to perform any one or more of the functions of the agent interface system 340 described and/or contemplated herein. In some embodiments, for example, the agent interface system 340 may include a personal computer system, a mobile computing device, a personal digital assistant, a public kiosk, a network device, and/or the like. As illustrated in FIG. 3, in accordance with some embodiments of the present invention, the agent interface system 340 includes a communication interface 342, a processor 344, a memory 346 having an account application 347 stored therein, and a user interface 349. In such embodiments, the communication interface 342 is operatively and selectively connected to the processor 344, which is operatively and selectively connected to the user interface 349 and the memory 346.

Each communication interface described herein, including the communication interface 342, generally includes hardware, and, in some instances, software, that enables a portion of the system 300, such as the agent interface system 340, to transport, send, receive, and/or otherwise communicate information to and/or from the communication interface of one or more other portions of the system 300. For example, the communication interface 342 of the agent interface system 340 may include a modem, server, electrical connection, and/or other electronic device that operatively connects the agent interface system 340 to another electronic device, such as the electronic devices that make up the management system 330.

Each processor described herein, including the processor 344, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the account application 347 of the memory 346 of the agent interface system 340.

Each memory device described herein, including the memory 346 for storing the account application 347 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the account application 347. In some embodiments, the account application 347 includes an interface for communicating with, navigating, controlling, configuring, and/or using the management system 330 and/or other portions of the system 300. For example, in some embodiments, the agent 345 may use the account application 347 to view (or edit, transmit to an external data system, and the like.) information associated with account 331. The agent 345 may also use the account application 347 to provide one or more services to the outsider or the outsider's account 331. Examples of services have been described earlier with respect to block 140 of FIG. 1. In some embodiments, the account application 347 includes computer-executable program code portions for instructing the processor 344 to perform one or more of the functions of the account application 347 described and/or contemplated herein. In some embodiments, the account application 347 may include and/or use one or more network and/or system communication protocols.

Also shown in FIG. 3 is the user interface 349. In some embodiments, the user interface 349 includes one or more user output devices, such as a display and/or speaker, for presenting information to the agent 345 and/or some other user. In some embodiments, the user interface 349 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 345 and/or some other user. In some embodiments, the user interface 349 includes the input and display devices of a personal computer, such as a keyboard and monitor, that are operable to receive and display information associated with the account.

FIG. 3 also illustrates a management system 330, in accordance with an embodiment of the present invention. The management system 330 may include any computerized apparatus that can be configured to perform any one or more of the functions of the management system 330 described and/or contemplated herein. In accordance with some embodiments, for example, the management system 330 may include a computer network, an engine, a platform, a server, a database system, a front end system, a back end system, a personal computer system, and/or the like. In some embodiments, such as the one illustrated in FIG. 3, the management system 330 includes a communication interface 332, a processor 334, and a memory 336, which includes a threat detection application 337 and a datastore 338 stored therein. As shown, the communication interface 332 is operatively and selectively connected to the processor 334, which is operatively and selectively connected to the memory 336.

It will be understood that the threat detection application 337 may be configured to implement any one or more portions of any one or more of the process flows 100 and/or 200 described and/or contemplated herein. As an example, in some embodiments, the threat detection application 337 is configured to receive first information associated with the outsider. As a further example, the threat detection application 337 is further configured to receive, from a data system (e.g., datastore) second information associated with the agent, where the agent provided the service to the outsider. As a further example, the threat detection application 337 is further configured to determine a threat based at least partially on determining, based at least partially on the first information and the second information, a relationship between the outsider and the agent. As a further example, the threat detection application 337 is further configured to determine a relationship between the outsider and the agent by determining a match between the first information and the second information. As a further example, the threat detection application 337 is further configured to identify an abnormal event as an event where the agent provides a benefit to the outsider, where the outsider does not qualify for the benefit, or changes a status associated with the outsider where the outsider does not qualify for the changed status. As a further example, the threat detection application 337 is further configured to identify an abnormal event as an event where the agent reads (or edits or transmits to an external data source or prints) account information associated with the outsider's account, or waives an assessment for the outsider, or lowers an interest rate associated with the outsider's account, or raises a credit limit associated with the outsider's account, or wires funds into or out of the outsider's account, or orders a new checkbook or extra credit cards, and the like. As a further example, the threat detection application 337 is further configured to identify an abnormal event as an event where includes the agent causes a detriment to the outsider, where the outsider does not qualify for the detriment. As a further example, the threat detection application 337 is further configured to identify an abnormal event as an event where the agent imposes an assessment for the outsider, or raises an interest rate associated with the outsider's account, or lowers a credit limit associated with the outsider's account, or transfers funds out of the outsider's account, and the like. As a further example, the threat detection application 337 is further configured to identify an abnormal event as an event that occurs without the permission or knowledge of the outsider and/or the entity.

As a further example, the threat detection application 337 is further configured to determine a relationship between the outsider and the agent by accessing a social network associated with the outsider (and/or the agent), and determining a direct connection between the outsider and the agent. As a further example, the threat detection application 337 may be further configured to determine a relationship between the outsider and the agent by accessing a social network associated with the outsider (and/or the agent), determining an indirect connection between the outsider and the agent via a connection path that includes one or more connections, where the connection path is a shortest connection path among a plurality of connection paths that connect the outsider and the agent, and determining the connection path is smaller than a predetermined connection path length.

As a further example, the threat detection application 337 may be further configured to access a social network associated with the outsider, determine one or more indirect connections between the outsider and the agent, and generate a connectedness factor based at least partially on the number of indirect connections between the outsider and the agent and the type of each indirect connection. As a further example, the threat detection application 337 may be further configured to dynamically determine a threshold connectedness factor associated with the agent, and determine the connectedness factor is greater than the threshold connectedness factor. As a further example, the threat detection application 337 may be further configured to calculate the threshold connectedness factor based at least partially on determining at least a predetermined number of interactions between the agent and the outsider during a predetermined period of time.

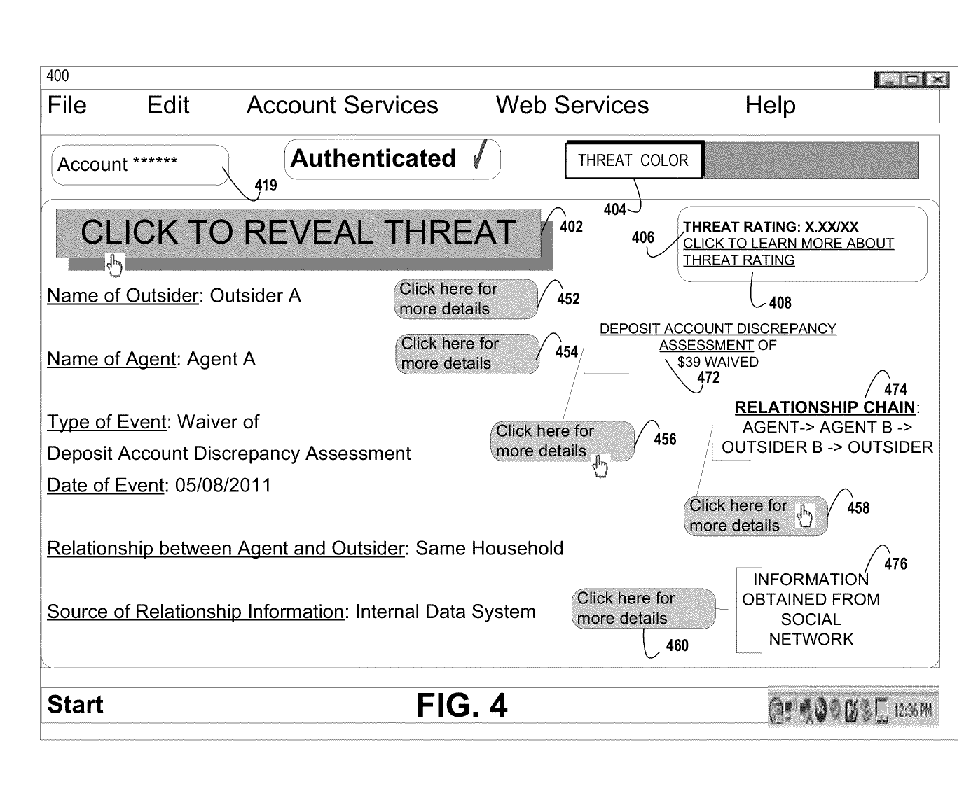

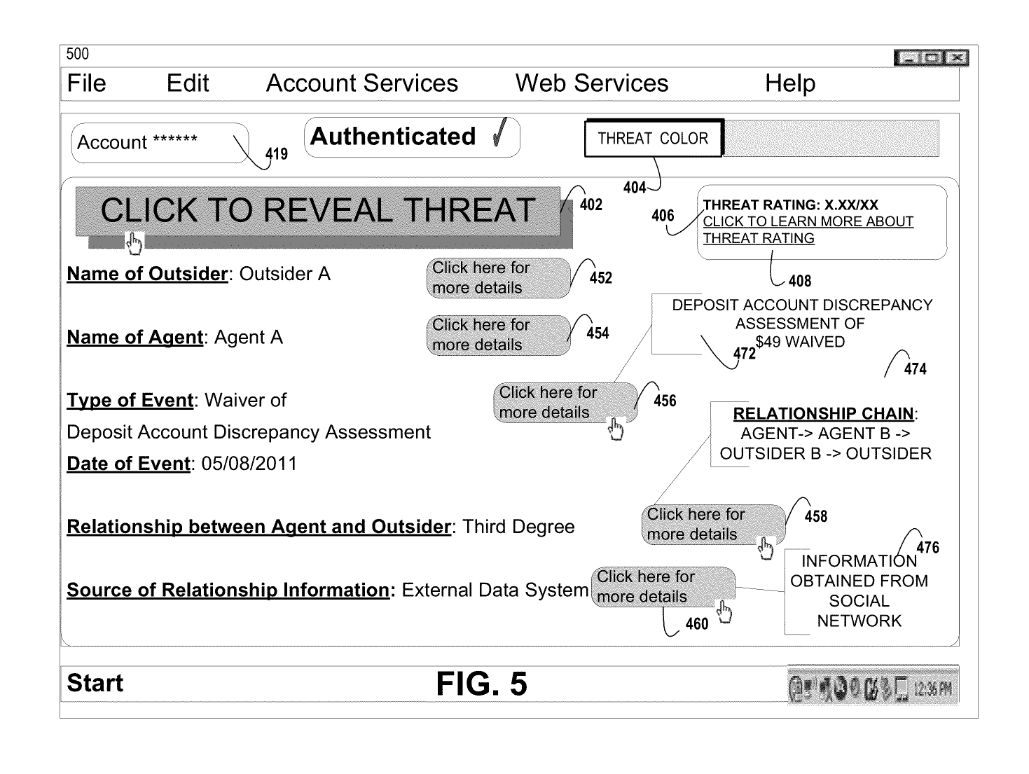

As a further example, the threat detection application 337 may be further configured to determine a threat by determining a threat rating based at least partially on the relationship between the agent and the outsider, and the abnormal event associated with the service, and further determining the threat rating is greater than a predetermined threat threshold. If the threat detection application determines a threat, the application initiates presentation of the threat to one or more personnel associated with the entity. For example, the threat detection application sends a link (e.g., via email) to the appropriate personnel. When the personnel selects the link, the application initiates presentation of a screenshot similar to that presented in FIG. 4 or FIG. 5.

It will also be understood that, in some embodiments, the memory includes other applications. For example, an application may be configured to provide account management services to the outsider 315 at the outsider interface system 320 such as, for example, any of the account management services described and/or contemplated herein. As another example, another application may be configured to allow the agent 345 to provide a service to the outsider 315. In some embodiments, the service may be associated with the outsider's account 331.

It will also be understood that, in some embodiments, the threat detection application 337 is configured to communicate with the datastore 338, the outsider interface system 320 and/or any one or more other portions of the system 300. As another example, in some embodiments, the threat detection application 337 is configured to create and/or send one or more notifications to the agent 345 at the agent interface system 340, to create and/or send one or more notifications to the outsider 315 at the outsider interface system 320, to create and/or send one or more notifications to other agents or personnel associated with the entity.

It will be further understood that, in some embodiments, the threat detection application 337 includes computer-executable program code portions for instructing the processor 334 to perform any one or more of the functions of the threat detection application 337 described and/or contemplated herein. In some embodiments, the threat detection application 337 may include and/or use one or more network and/or system communication protocols.

In addition to the threat detection application 337, the memory 336 also includes the datastore 338. As used herein, the datastore 338 may be one or more distinct and/or remote datastores. In some embodiments, the datastore 338 is not located within the management system and is instead located remotely from the management system. In some embodiments, the datastore 338 stores information (e.g., second information—block 120 of FIG. 1) regarding one or more agents associated with the entity. In some embodiments, the datastore 338 stores information (e.g., first information—block 120 of FIG. 1) regarding one or more outsiders. In some embodiments, the datastore 338 stores information (e.g., third information—block 140 of FIG. 1) regarding instances of services rendered by agents to outsiders or outsiders' accounts.

It will be understood that the datastore 338 may include any one or more storage devices, including, but not limited to, datastores, databases, and/or any of the other storage devices typically associated with a computer system. It will also be understood that the datastore 338 may store information in any known way, such as, for example, by using one or more computer codes and/or languages, alphanumeric character strings, data sets, figures, tables, charts, links, documents, and/or the like. Further, in some embodiments, the datastore 338 may include information associated with one or more applications, such as, for example, the threat detection application 337. It will also be understood that, in some embodiments, the datastore 338 provides a substantially real-time representation of the information stored therein, so that, for example, when the processor 334 accesses the datastore 338, the information stored therein is current or substantially current.

It will be understood that the embodiment illustrated in FIG. 3 is exemplary and that other embodiments may vary. As another example, in some embodiments, the management system 330 includes more, less, or different components, such as, for example, an account manager user interface. As another example, in some embodiments, some or all of the portions of the system 300 may be combined into a single portion. Specifically, in some embodiments, the agent interface system 340 and the management system 330 are combined into a single agent interface and management system configured to perform all of the same functions of those separate portions as described and/or contemplated herein. Likewise, in some embodiments, some or all of the portions of the system 300 may be separated into two or more distinct portions.

In addition, the various portions of the system 300 may be maintained for and/or by the same or separate parties. For example, as previously mentioned, a single financial institution may maintain the account 331 and the management system 330. However, in other embodiments, the account 331 and the management system 330 may each be maintained by separate parties.

It will also be understood that the system 300 may include and/or implement any embodiment of the present invention described and/or contemplated herein. For example, in some embodiments, the system 300 is configured to implement any one or more of the embodiments of the process flow 100 described and/or contemplated herein in connection with FIG. 1, any one or more of the embodiments of the process flow 200 described and/or contemplated herein in connection with FIG. 2, and/or any one or more of the embodiments of the system 300 described and/or contemplated herein in connection with FIG. 3.

FIGS. 4 and 5 illustrate example screenshots of threats that were identified by an apparatus as being associated with an agent's provision of a service to an outsider. The screenshots discussed below with respect to various process blocks are mere examples of screenshots in some embodiments of the invention. In other embodiments of the invention, the screenshots may include additional features not described herein, or may not include each and every feature described herein. As used with respect to the various screenshots of FIGS. 4 and 5, an “apparatus” may be the management system 330 depicted in FIG. 3. The apparatus may generate, or initiate generation of, the screenshots presented in FIGS. 4 and 5 and may cause the presentation of one or more elements in each screenshot presented in FIGS. 4 and 5.

FIG. 4 presents an example screenshot of a page 400 that is presented to personnel associated with the entity when the apparatus determines a threat at block 220. In order to view the page 400, the personnel may need to authenticate himself/herself to the ‘insider threat’ application. In some embodiments, the apparatus may not automatically present details about the threat. The personnel may need to select a selectable option 402 (e.g., a digital button) in order to reveal the threat.

FIG. 4 presents the name of the outsider and a selectable option (e.g., a digital button) that allows the personnel to view more information regarding the outsider (e.g., by selecting the button 452, the personnel may be directed to a page or a pop-up window that presents information received at block 100). In some embodiments where an account is associated with an event for which a threat is detected, the apparatus may present account identifying information, e.g., the account number 419.

FIG. 4 also presents the name of the agent and a selectable option (e.g., a digital button) that allows the personnel to view more information regarding the agent (e.g., by selecting the button 454, the personnel may be directed to a page or a pop-up window that presents information received at block 200). FIG. 4 also presents the type of event and a selectable option (e.g., a digital button) that allows the personnel to view more information regarding the event (e.g., by selecting the button 456, the personnel may be directed to a page or a pop-up window that presents information received at block 300). For instance, when the personnel selects digital button 456, the apparatus opens a pop-up window 472 that indicates the event is a waiver of a deposit account discrepancy assessment associated with the outsider's account. FIG. 4 also presents the date on which the event occurred.

FIG. 4 also presents the relationship between the agent and the outsider, and a selectable option (e.g., a digital button) that allows the personnel to view more information regarding the relationship as determined by the apparatus (e.g., by selecting the button 458, the personnel may be directed to a page or a pop-up window that presents the relationship determined at block 130 and/or block 208). For instance, when the personnel selects digital button 458, the apparatus opens a pop-up window 474 that indicates the agent and the outsider share the same telephone number. FIG. 4 also presents the source of the determined relationship information (e.g., internal data system), and a selectable option (e.g., a digital button) that allows the personnel to view more information regarding the internal data system (e.g., by selecting the button 460, the personnel may be directed to a page or a pop-up window that presents further details regarding the internal data system).

FIG. 4 also presents the threat rating 406 as determined by the apparatus at block 216 of FIG. 2. FIG. 4 also presents a selectable link that allows the personnel to learn more about the determined threat rating. For instance, by selecting the ‘Click to Learn More About Threat Rating’ option, the personnel is directed to another page or a pop-up window that explains the factors that went into generating the threat rating. For example, the explanation may indicate that the threat rating is high because there is a high likelihood that the outsider and the agent are related because they share the same phone number and, consequently, the same household. The explanation presented in the pop-up window or on the separate page may also indicate that there is a high likelihood that the agent waived the deposit account discrepancy assessment because of the relationship between the agent and the outsider. FIG. 4 also presents the threat color 404 associated with the threat rating 406. As explained earlier, for example, a threat rating of 0 may be associated with a white color graph, and threat rating of 10 may be associated with a black color graph. Therefore, since the determined threat rating is 7.55, the threat color graph is a darker shade of grey rather than a lighter shade of grey.

FIG. 5 presents another example screenshot of a page 500 that is presented to the personnel associated with the entity when the apparatus determines a threat at block 220. The relationship that is determined by the apparatus in FIG. 5 is different from the relationship determined by the apparatus in FIG. 4. FIG. 5 also presents the relationship between the agent and the outsider, and a selectable option (e.g., a digital button) that allows the personnel to view more information regarding the relationship as determined by the apparatus (e.g., by selecting the button 458, the personnel may be directed to a page or a pop-up window that presents the relationship determined at block 130 and/or block 208). For instance, when the personnel selects digital button 458, the apparatus opens a pop-up window 474 that indicates a third degree connection between the outsider and the agent (Agent No. 1 is connected to Outsider No. 2, who is in turn connected to Outsider No. 3, who is in turn connected to the outsider Outsider No. 1). FIG. 4 also presents the source of the determined relationship information (e.g., external data system such as a social network), and a selectable option (e.g., a digital button) that allows the personnel to view more information regarding the external data system (e.g., by selecting the button 460, the personnel may be directed to a page or a pop-up window that presents further details regarding the social network).

FIG. 5 also presents the threat rating 406 as determined by the apparatus at block 216 of FIG. 2. FIG. 5 also presents a selectable link that allows the personnel to learn more about the determined threat rating. For instance, by selecting the ‘Click to Learn More About Threat Rating’ option, the personnel is directed to another page or a pop-up window that explains the factors that went into the generating the threat rating. For example, the explanation may indicate that the threat rating is neutral because there is only a small likelihood that the agent waived the deposit account assessment because the relationship between the agent and the outsider is a third degree relationship. FIG. 5 also presents the threat color 404 associated with the threat rating 406. As explained earlier, for example, a threat rating of 0 may be associated with a white color graph, and threat rating of 10 may be associated with a black color graph. Therefore, since the determined threat rating is 5.55, the threat color graph is a lighter shade of grey rather than a darker shade of grey.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, and the like.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, and the like.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A method comprising:
receiving first information associated with an outsider;
receiving, from a data system, second information associated with an agent who provided a service to the outsider; and
determining a threat based at least partially on:
determining, based at least partially on the first information and the second information, a relationship between the outsider and the agent.

2. The method of claim 1, further comprising:
receiving third information associated with the agent's provision of the service to the outsider; and
determining a threat based at least partially on:
determining, based at least partially on the third information, an abnormal event associated with the service.

3. The method of claim 1, wherein the first information comprises a full or a partial portion of a first name, a last name, a phone number, a mailing address, and an email address, wherein the outsider provides the first information.

4. The method of claim 3, wherein the second information comprises a full or a partial portion of a first name, a last name, a phone number, a mailing address, and an email address.

5. The method of claim 4, wherein determining a relationship between the outsider and the agent comprises:
determining a match between the first information and the second information.

6. The method of claim 2, wherein the abnormal event comprises at least one of the agent providing a benefit to the outsider wherein the outsider does not qualify for the benefit and the agent changing a status associated with the outsider wherein the outsider does not qualify for the changed status.

7. The method of claim 2, wherein the abnormal event comprises at least one of the agent waiving an assessment for the outsider, lowering an interest rate associated with the outsider's account, raising a credit limit associated with the outsider's account, and transferring funds into the outsider's account.

8. The method of claim 2, wherein the abnormal event comprises the agent causing a detriment to the outsider, wherein the outsider does not qualify for the detriment.

9. The method of claim 2, wherein the abnormal event comprises at least one of the agent imposing an assessment for the outsider, raising an interest rate associated with the outsider's account, lowering a credit limit associated with the outsider's account, and transferring funds out of the outsider's account.

10. The method of claim 2, wherein the abnormal event occurs without permission of the outsider.

11. The method of claim 3, wherein the first information further comprises a full or a partial portion of at least one of a username and a screen name associated with the outsider on a network.

12. The method of claim 3, wherein the first information further comprises at least one of a network location from where the outsider provided the first information, or an identifier associated with a device from which the outsider provided the first information, or an identity of an application via which the outsider provided the first information.

13. The method of claim 4, wherein the second information further comprises a full or a partial portion of at least one of a username and a screen name utilized by the agent on a network.

14. The method of claim 4, wherein the second information further comprises at least one of a location from which the agent accessed a network, or an identifier associated with a device with which the agent accessed the network, or an identity of an application via which the agent accessed the network.

15. The method of claim 1, wherein determining a relationship between the outsider and the agent further comprises:
accessing a social network associated with the outsider; and
determining a direct connection between the outsider and the agent.

16. The method of claim 1, wherein determining a relationship between the outsider and the agent further comprises:
accessing a social network associated with the outsider;
determining an indirect connection between the outsider and the agent via a connection path that comprises one or more connections, wherein the connection path is a shortest connection path among a plurality of connection paths that connect the outsider and the agent; and
determining the connection path is smaller than a predetermined connection path length.

17. The method of claim 1, wherein determining a relationship between the outsider and the agent further comprises:
accessing a social network associated with the outsider;
determining one or more indirect connections between the outsider and the agent; and
generating a connectedness factor based at least partially on the number of indirect connections between the outsider and the agent and the type of each indirect connection.

18. The method of claim 17, further comprising:
dynamically determining a threshold connectedness factor associated with the agent; and
determining the connectedness factor is greater than the threshold connectedness factor.

19. The method of claim 18, wherein the threshold connectedness factor is calculated based at least partially on determining at least a predetermined number of interactions between the agent and the outsider during a predetermined period of time.

20. The method of claim 2, wherein determining a threat comprises:
determining a threat rating based at least partially on:
the relationship between the agent and the outsider, and
the abnormal event associated with the service;
determining the threat rating is greater than a predetermined threat threshold; and
initiating presentation of the threat.

21. An apparatus comprising:
a memory;
a processor; and
a module stored in the memory, executable by the processor, and configured to:
receive first information associated with an outsider;
receive, from a data system, second information associated with an agent who provided a service to the outsider; and
determine a threat based at least partially on:
determining, based at least partially on the first information and the second information, a relationship between the outsider and the agent.

22. The apparatus of claim 21, wherein the module is further configured to:
receive third information associated with the agent's provision of the service to the outsider; and
determine a threat based at least partially on:
determining, based at least partially on the third information, an abnormal event associated with the service.

23. The apparatus of claim 21, wherein the first information comprises a full or a partial portion of a first name, a last name, a phone number, a mailing address, and an email address, wherein the outsider provides the first information.

24. The apparatus of claim 23, wherein the second information comprises a full or a partial portion of a first name, a last name, a phone number, a mailing address, and an email address.

25. The apparatus of claim 24, wherein to determine a relationship between the outsider and the agent, the module is further configured to:
determine a match between the first information and the second information.

26. The apparatus of claim 22, wherein the abnormal event comprises at least one of the agent providing a benefit to the outsider wherein the outsider does not qualify for the benefit and the agent changing a status associated with the outsider wherein the outsider does not qualify for the changed status.

27. The apparatus of claim 22, wherein the abnormal event comprises at least one of the agent waiving an assessment for the outsider, lowering an interest rate associated with the outsider's account, raising a credit limit associated with the outsider's account, and transferring funds into the outsider's account.

28. The apparatus of claim 22, wherein the abnormal event comprises the agent causing a detriment to the outsider, wherein the outsider does not qualify for the detriment.

29. The apparatus of claim 22, wherein the abnormal event comprises at least one of the agent imposing an assessment for the outsider, raising an interest rate associated with the outsider's account, lowering a credit limit associated with the outsider's account, and transferring funds out of the outsider's account.

30. The apparatus of claim 22, wherein the abnormal event occurs without permission of the outsider.

31. The apparatus of claim 23, wherein the first information further comprises a full or a partial portion of at least one of a username and a screen name associated with the outsider on a network.

32. The apparatus of claim 23, wherein the first information further comprises at least one of a network location from where the outsider provided the first information, or an identifier associated with a device from which the outsider provided the first information, or an identity of an application via which the outsider provided the first information.

33. The apparatus of claim 24, wherein the second information further comprises a full or a partial portion of at least one of a username and a screen name utilized by the agent on a network.

34. The apparatus of claim 24, wherein the second information further comprises at least one of a location from which the agent accessed a network, or an identifier associated with a device with which the agent accessed the network, or an identity of an application via which the agent accessed the network.

35. The apparatus of claim 21, wherein to determine a relationship between the outsider and the agent, the module is further configured to:
access a social network associated with the outsider; and
determine a direct connection between the outsider and the agent.

36. The apparatus of claim 21, wherein to determine a relationship between the outsider and the agent, the module is further configured to:
access a social network associated with the outsider;
determine an indirect connection between the outsider and the agent via a connection path that comprises one or more connections, wherein the connection path is a shortest connection path among a plurality of connection paths that connect the outsider and the agent; and
determine the connection path is smaller than a predetermined connection path length.

37. The apparatus of claim 21, wherein to determine a relationship between the outsider and the agent, the module is further configured to:
access a social network associated with the outsider;
determine one or more indirect connections between the outsider and the agent; and
generate a connectedness factor based at least partially on the number of indirect connections between the outsider and the agent and the type of each indirect connection.

38. The apparatus of claim 37, wherein the module is further configured to:
dynamically determine a threshold connectedness factor associated with the agent; and
determine the connectedness factor is greater than the threshold connectedness factor.

39. The apparatus of claim 38, wherein the threshold connectedness factor is calculated based at least partially on determining at least a predetermined number of interactions between the agent and the outsider during a predetermined period of time.

40. The apparatus of claim 22, wherein to determine a threat, the module is further configured to:
determine a threat rating based at least partially on:
the relationship between the agent and the outsider, and
the abnormal event associated with the service;
determine the threat rating is greater than a predetermined threat threshold; and
initiate presentation of the threat.

41. A computer program product comprising:
a non-transitory computer-readable medium comprising a set of codes for causing a computer to:
receive first information associated with an outsider;
receive, from a data system, second information associated with an agent who provided a service to the outsider; and
determine a threat based at least partially on:
determining, based at least partially on the first information and the second information, a relationship between the outsider and the agent.

42. The computer program product of claim 41, wherein the set of codes further causes a computer to:
receive third information associated with the agent's provision of the service to the outsider; and
determine a threat based at least partially on:
determining, based at least partially on the third information, an abnormal event associated with the service.

43. The computer program product of claim 41, wherein the first information comprises a full or a partial portion of a first name, a last name, a phone number, a mailing address, and an email address, wherein the outsider provides the first information.

44. The computer program product of claim 43, wherein the second information comprises a full or a partial portion of a first name, a last name, a phone number, a mailing address, and an email address.

45. The computer program product of claim 44, wherein to determine a relationship between the outsider and the agent, the set of codes further causes a computer to:
determine a match between the first information and the second information.

46. The computer program product of claim 42, wherein the abnormal event comprises at least one of the agent providing a benefit to the outsider wherein the outsider does not qualify for the benefit and the agent changing a status associated with the outsider wherein the outsider does not qualify for the changed status.

47. The computer program product of claim 42, wherein the abnormal event comprises at least one of the agent waiving an assessment for the outsider, lowering an interest rate associated with the outsider's account, raising a credit limit associated with the outsider's account, and transferring funds into the outsider's account.

48. The computer program product of claim 42, wherein the abnormal event comprises the agent causing a detriment to the outsider, wherein the outsider does not qualify for the detriment.

49. The computer program product of claim 42, wherein the abnormal event comprises at least one of the agent imposing an assessment for the outsider, raising an interest rate associated with the outsider's account, lowering a credit limit associated with the outsider's account, and transferring funds out of the outsider's account.

50. The computer program product of claim 42, wherein the abnormal event occurs without permission of the outsider.

51. The computer program product of claim 43, wherein the first information further comprises a full or a partial portion of at least one of a username and a screen name associated with the outsider on a network.

52. The computer program product of claim 43, wherein the first information further comprises at least one of a network location from where the outsider provided the first information, or an identifier associated with a device from which the outsider provided the first information, or an identity of an application via which the outsider provided the first information.

53. The computer program product of claim 44, wherein the second information further comprises a full or a partial portion of at least one of a username and a screen name utilized by the agent on a network.

54. The computer program product of claim 44, wherein the second information further comprises at least one of a location from which the agent accessed a network, or an identifier associated with a device with which the agent accessed the network, or an identity of an application via which the agent accessed the network.

55. The computer program product of claim 41, wherein to determine a relationship between the outsider and the agent, the set of codes further causes a computer to:
access a social network associated with the outsider; and
determine a direct connection between the outsider and the agent.

56. The computer program product of claim 41, wherein to determine a relationship between the outsider and the agent, the set of codes further causes a computer to:
access a social network associated with the outsider;
determine an indirect connection between the outsider and the agent via a connection path that comprises one or more connections, wherein the connection path is a shortest connection path among a plurality of connection paths that connect the outsider and the agent; and
determine the connection path is smaller than a predetermined connection path length.

57. The computer program product of claim 41, wherein to determine a relationship between the outsider and the agent, the set of codes further causes a computer to:
access a social network associated with the outsider;
determine one or more indirect connections between the outsider and the agent; and
generate a connectedness factor based at least partially on the number of indirect connections between the outsider and the agent and the type of each indirect connection.

58. The computer program product of claim 57, wherein the set of codes further causes a computer to:
dynamically determine a threshold connectedness factor associated with the agent; and
determine the connectedness factor is greater than the threshold connectedness factor.

59. The computer program product of claim 58, wherein the threshold connectedness factor is calculated based at least partially on determining at least a predetermined number of interactions between the agent and the outsider during a predetermined period of time.

60. The computer program product of claim 42, wherein to determine a threat, the set of codes further causes a computer to:
determine a threat rating based at least partially on:
the relationship between the agent and the outsider, and
the abnormal event associated with the service;
determine the threat rating is greater than a predetermined threat threshold; and
initiate presentation of the threat.
